(19) United States
(12) Patent Application Publication
(10) Pub. No.: US 2016/0021895 A1
(43) Pub. Date: Jan. 28, 2016

(54) COOKING PRODUCT COMPRISING MICROALGAL FLOUR IN THE FORM OF GRANULES AND PRODUCTION METHOD

(71) Applicant: ROQUETTE FRERES, Lestrem (FR)

(72) Inventors: PATRICK LEROUX, ESTAIRES (FR); MARIE DELEBARRE, LA COUTURE (FR); THOMAS BOURSIER, MONS EN BAROEUL (FR)

(21) Appl. No.: 14/776,930

(22) PCT Filed: Mar. 14, 2014
(86) PCT No.: PCT/EP2014/055063

§ 371 Date: Sep. 15, 2015

(30) Foreign Application Priority Data
Mar. 15, 2013 (EP) 13159385.7
Jun. 21, 2013 (FR) 1355895

(51) Int. Cl. A21D 2/36; A23L 1/337; A21D 2/18; A21D 13/06; A21D 13/04

(52) U.S. Cl. CPC A21D 2/36; A21D 13/066; A21D 13/04; A21D 2/186; A23L 1/337; A21D 13/068; A23V 2002/00

(57) ABSTRACT

The invention relates to a novel cooking product characterised in that at least one of the three ingredients selected from among eggs or egg products, milk or milk derivatives and fatty substances of animal and/or plant origin is completely or partially replaced with microalgal flour. The novel cooking product can in some cases be consumed by allergic and/or vegetarian persons. The invention also relates to the method for the production of said cooking product.

### FIELD OF THE INVENTION

The present invention relates to a novel baked product comprising microalgal flour. The novel baked product can therefore in certain cases be consumed by allergic and/or vegetarian individuals. The invention also relates to the process for producing said microalgal flour. Finally, the invention also relates to the process for producing said baked products.

### TECHNOLOGICAL BACKGROUND

Bread, and more generally breadmaking products, are the result of very complex physical transformations, chemical reactions and biological activities which occur within a mixture of flour derived from breadmaking cereals, water, salt and yeast, and sometimes other ingredients (ascorbic acid, flour of other origins, exogenous enzymes, emulsifiers, etc), under the action of a controlled input of mechanical and thermal energy

The formulation differs with the types of bread. Traditional bread is free of sugar, milk and fats. Vienna bread contains, in addition to the ingredients found in traditional bread, sugar, fats and milk powder, but does not contain eggs. As for sandwich bread, it contains the same ingredients as Vienna bread, but in different proportions with the optional presence of milk powder. Sweet buns and brioche bread contain all the ingredients mentioned above with, in addition, the presence of eggs, but in different proportions.

Thus, more complex breadmaking products may contain eggs, milk and butter, in addition to the traditional ingredients.

Some of these ingredients are known to be allergenic and can cause reactions which are very bothersome, or even dangerous, in everyday life. Food allergies are constantly on the increase. They have gone from 1% in 1970 to 6 to 8% of the population today. Allergies of this type more readily involve young children (7% to 8% are thus involved), while the percentage of adults ranges from 3 to 4%. Furthermore, the number of cases of severe allergies is also tending to increase. Thus, the increasing number of anaphylactic shocks directly linked to the consumption of allergenic food products has risen by 700% in 17 years!

Dairy product allergy is one of the most widespread allergic reactions. Studies demonstrate that 65% of individuals who suffer from food allergies are allergic to milk. The adult form of milk allergy, herein referred to as “dairy product allergy”, is a reaction of the immune system which creates antibodies in order to combat the unwanted food. This allergy is different than cow's milk protein (bovine protein) allergy, also referred to as CMPA, which affects newborns and infants. The clinical manifestations of this allergy are mainly gastrointestinal (50 to 80% of cases), and also cutaneous (10 to 39% of cases) and respiratory (19% of cases). This allergy is the first food allergy to appear in children, and most commonly begins in infants less than a year old. CMPA causes varied symptoms, such as urticaria, eczema, angio-odema possibly affecting the face, the lips, the tongue, the soft palate, the larynx and the vocal cords in serious cases, constipation, diarrhea, flatulence, nausea, migraines, infections, abdominal cramps, nasal congestion and even serious asthma attacks. CMPA can also manifest itself through anaphylactic shock and also through a syndrome termed “near-miss sudden death”, and observations of newborn sudden deaths related to cow's milk anaphylaxis have even been reported.

Allergic individuals should completely eliminate milk, dairy products and derivatives thereof from their diet. Furthermore, milks from other animal species are contraindicated in the event of CMPA. The following terms are indicators of the presence of cow's milk or derivatives thereof in the ingredients of a product: buttermilk, calcium caseinate, sodium caseinate, casein, caseinate, hydrolyzed caseinate, dried milk solids, lactalbumin, lactoglobulin, low-fat milk, milk powder, condensed milk and whey.

However, milk has become a central food in human nutrition. Milk is a food which contains a not insignificant protein source of high biological quality. Proteins represent, after carbohydrates and lipids, the third major energy source in our diet. They are essential to our survival and are provided both by products of animal origin (meat, fish, eggs, dairy products) and by plant foods (cereals, leguminous plants, etc). For a long time, animal proteins have proved to be tremendously successful in terms of their excellent nutritional qualities since they contain all the essential amino acids in adequate proportions. On the other hand, none of the various sources of vegetable proteins can, by themselves, cover all the amino acid needs: one or more essential amino acids are often lacking.

Among the other widespread food allergies, egg allergy is also a significant problem. The major egg allergens are albumin (a heat-labile protein destroyed by heat) and ovomucoid (a heat-labile protein resistant to heat). In the latter case, cooking the egg does not protect against the allergy.

An egg allergy usually occurs during the first year of life, when eggs are, for the first time, added to a baby's diet. Although egg allergy generally disappears around the age of 5 or 7, in some it is present for life. It is essential to learn to live with it while at the same time eliminating its dangers. Egg allergy represents 30% of food allergies in children.

It is caused by the reaction of the immune system to the ingestion of egg protein. In order for a food allergy to occur, two factors must be present, namely a genetic predisposition and contact with the food. The seriousness of the allergic reaction may be benign or may endanger the life of the individual affected thereby, depending on the individual and the amount of egg consumed. In addition, although egg white causes a more serious reaction than egg yolk, allergic individuals must avoid the food in its entirety. It is virtually impossible to completely separate the yolk from the white. Furthermore, a very small amount of the allergenic protein is sufficient to cause a considerable allergic reaction.

The symptoms generally occur only a few minutes after the egg has been eaten. However, it is also possible for reactions to appear from 2 to 4 hours after ingestion. The most common symptoms are nausea, vomiting, cramps, diarrhea, a tingling sensation in the mouth, skin rashes and redness, itching, urticaria, eczema, runny nose, sneezing, difficulty breathing, cough, wheezing, and irritated and watery eyes. An anaphylactic shock may be seen in very rare cases.

Eggs are among the healthiest foods. They contain quality proteins and also essential vitamins and minerals, including folic acid, vitamin B12, zinc, iron and phosphorus. The elimination of eggs from a diet considerably reduces the meal choice possibilities and prevents benefiting from the numerous dietary advantages that they provide.

Thus, individuals who suffer from food allergies to milk proteins and/or to eggs are looking for products which are totally free of these allergens.

Furthermore, vegetarians and vegans also refuse to consume any animal-derived products and consequently boycott all food products containing them.

Finally, some individuals concerned about their figure and their health want to consume products which are low in fat and in cholesterol and which have a low calorie content.

A very large number of research studies have been carried out in order to propose more or less complex solutions for formulating nonallergenic breadmaking products which can also be consumed by vegans and/or vegetarians and/or individuals concerned about their figure and their health.

Application US 2010/0297296, which provides breadmaking products which are termed healthy and which contain microalgae as a total or partial replacement for the eggs and/or butter present in basic recipes, is in particular known. On the other hand, at no time does this document provide recipes for replacing dairy proteins.

Application WO 2013/049337 also discloses preparations for preparing baked breadmaking products comprising flour, a leavening agent, a solid or semi-solid fat compound and a carbonated liquid chosen from club soda, sparkling water, seltzer water, beverages with artificial sweeteners and sugared beverages. On the other hand, the preparations disclosed in said document nevertheless still contain eggs or egg products and/or milk or milk-derived products.

On the other hand, the known solutions of the prior art very often result in products which have a poorer final quality, in particular in terms of texture and taste.

There is therefore a real need to replace allergenic ingredients and/or fats of animal origin in breadmaking products so as to allow the consumption thereof by allergic, vegetarian and vegan individuals and all those concerned about their figure, their fitness and their health. The solutions proposed should result in products which have the same organoleptic properties as the “conventional” products. Moreover, the solutions proposed should be able to be used by those skilled in the art without any drastic change in the recipes and preferably on a large scale.

### SUMMARY OF THE INVENTION

Armed with this observation and after numerous research studies, the applicant company has, to its credit, met all the required demands and has found that such an objective can be achieved as long as a microalgal flour is used as an ingredient in breadmaking products intended to be baked before they are consumed. It is therefore to the credit of the applicant to have discovered that a microalgal flour can, surprisingly and unexpectedly compared with the prerequisites of the prior art, advantageously replace eggs or egg products, milk or milk-derived products and fats of animal and/or vegetable origin in breadmaking products, while at the same time keeping organoleptic qualities, in particular gustative, olfactory, visual and tactile properties, at least equivalent, or even superior, to those of conventional baked products containing these ingredients.

Another technical problem to be solved was the lipid content of the microalgal flours. Indeed, since this content is at least 10%, 25% or even 50% by weight of the dry powder, the production of a dry powder which is tacky and flows with difficulty is generally lamentable. Various flow agents (including silica-derived products) must then be added. Problems of water-dispersibility of the dried biomass flours, which is then have poorer wettability properties, may also be encountered.

There is therefore still an unmet need for novel stabilized forms of microalgal flour rich in lipids and/or in proteins, in order to make it possible to easily incorporate them, on a large scale, into food products which must remain delicious and nutritious.

The applicant company has therefore found that this need can be met by providing microalgal flour granules which have a particular particle size distribution, and notable flow and wettability properties. Thus, a subject of the present invention is a baked product, characterized in that it is obtained by adding, to the ingredients of the baked product, microalgal flour in the form of granules having one or more of the following characteristics:
a monomodal particle size distribution, measured on a Coulter® LS laser particle size analyzer, of between 2 and 400 μm, centered on a particle diameter (D mode) between 5 and 15 μm,
flow grades, determined according to a test A, between 0.5% and 60% by weight for the oversize at 2000 μm, between 0.5% and 60% by weight for the oversize at 1400 μm and between 0.5% and 95% by weight for the oversize at 800 μm,
a degree of wettability, expressed according to a test B, by the height of the product decanted in a beaker, at a value of between 0 and 4 cm, preferably between 0 and 2 cm, and more preferentially between 0 and 0.5 cm.

Preferably, the granules have the three characteristics.

Preferably, the microalgal flour content of the baked product is between 0.1% and 40%, more preferentially between 0.5% and 25% and even more preferentially between 1% and 10% of the total weight of the ingredients used in the recipe for preparing said product.

In a first preferred embodiment, the baked product is characterized in that at least one of the three ingredients chosen from eggs or egg products, milk or milk derivatives and fats of animal and/or vegetable origin has been partially or totally replaced with microalgal flour.

In a second preferential mode of the invention, the baked product is characterized in that at least two of the three ingredients chosen from eggs or egg products, milk or milk derivatives and fats of animal and/or vegetable origin have been partially or totally replaced with microalgal flour.

In a third preferential embodiment of the invention, the baked product is characterized in that all the ingredients chosen from eggs or egg products, milk or milk derivatives and fats of animal and/or vegetable origin have been partially or totally replaced with microalgal flour.

According to the invention, the baked product can be characterized in that the replacement of the eggs or egg products, of the milk or milk derivatives and/or of the fats of animal and/or vegetable origin is total.

In one aspect of the invention, said baked product does not contain gluten.

According to the invention, the microalgal flour is preferably a flour in which the microalgae are of the Chlorella genus, and more particularly of the Chlorella protothecoides species.

Preferably, the microalgal biomass contains at least 12%, at least 25%, at least 50% or at least 75% by the dry weight of lipids, and/or at least 30% by dry weight of proteins, at least 40% or at least 45% by dry weight of proteins.

In a first embodiment of the invention, the microalgal flour is in the form of non-lysed cells.

In a second embodiment of the invention, the microalgal flour is in the form of partially lysed cells and contains from 25% to 75% of lysed cells.

In a final embodiment of the invention, the microalgal flour is in the form of strongly lysed cells and contains 85% or more of lysed cells, preferably 90% or more.

Preferably, the baked product is a breadmaking product, in particular a brioche.

The present invention also relates to the use of the microalgal flour in the form of granules, as defined in the present document, for preparing a baked product, preferably a breadmaking product. In particular, in the context of this use, the microalgal flour totally or partially replaces at least one, two or three of the three ingredients chosen from eggs or egg products, milk or milk derivatives and fats of animal and/or vegetable origin.

The present invention also relates to a process for preparing a baked product as defined in the present document, characterized in that it comprises the following steps:
mixing the various ingredients until a dough is obtained, and
baking said dough.

Preferably, the process is characterized in that at least one, two or three of the three ingredients chosen from eggs or egg products, milk or milk derivatives and fats of animal and/or vegetable origin is totally or partially replaced with the microalgal flour in the form of granules, as defined in the present document.

Thus, the present invention relates to a process intended for preserving or improving the organoleptic qualities of a baked product, in particular a breadmaking product, while at the same time reducing the content of at least one, two or three of the three ingredients chosen from eggs or egg products, milk or milk derivatives and fats of animal and/or vegetable origin, consisting in totally or partially replacing it (them) with the microalgal flour in the form of granules, as defined in the present document.

The invention also relates to a process for preparing the microalgal flour granules used in said baked product, comprising the following steps:
1) preparing an emulsion of microalgal flour with a solids content of between 15% and 40% by dry weight,
2) introducing this emulsion into a high-pressure homogenizer,
3) spraying in a vertical spray-dryer equipped with a moving belt at its base, and with a high-pressure nozzle in its upper part, while at the same time regulating:

a) the pressure applied at the level of the spray nozzles at values of more than 100 bar, preferably between 100 and 200 bar, and more preferably between 160 and 170 bar,

b) the input temperature between 150° C. and 250° C., preferably between 180° C. and 200° C., and

c) the output temperature in this spray-drying zone between 60° C. and 120° C., preferably between 60° C. and 110° C. and more preferably between 60° C. and 80° C.,
4) regulating the input temperatures of the drying zone on the moving belt between 40° C. and 90° C., preferably between 60° C. and 90° C., and the outlet temperature between 40° C. and 80° C., and regulating the input temperatures of the cooling zone at a temperature between 10° C. and 40° C., preferably between 10° C. and 25° C., and the output temperature between 20° C. and 80° C., preferably between 20° C. and 60° C.,
5) collecting the microalgal flour granules thus obtained.

### DETAILED DESCRIPTION OF EMBODIMENTS

A subject of the present invention is a baked product characterized in that it is obtained by adding, to the ingredients of the baked product, microalgal flour in the form of granules, as defined in the present document.

One advantage of the present invention is the capacity of the microalgal flour in the form of granules, as defined in the present document, to totally or partially replace eggs or egg products, milk or milk derivatives and/or fats of animal and/or vegetable origin while at the same time preserving the organoleptic qualities of the baked product, or even improving them. In addition, this replacement can be carried out without changing, at the very least substantially, the recipes for preparing baked products.

Thus, in a first preferential mode of the invention, the baked product is characterized in that at least one of the three ingredients chosen from eggs or egg products, milk or milk derivatives and fats of animal and/or vegetable origin has been partially or totally replaced with microalgal flour. In one particular embodiment, the milk or milk derivatives have been partially or totally replaced. In another particular embodiment, the eggs or egg products have been partially or totally replaced. In an additional particular embodiment, the fats of animal and/or vegetable origin have been partially or totally replaced.

The term “totally” is intended to mean that the baked product does not comprise the replaced ingredients, preferably even in trace amounts. The term “partially” is intended to mean that, in comparison with the recipe use, the content of the route ingredient replaced is reduced by at least 10%, 20%, 30%, 40%, 50%, 60%, 70%, 80% or 90% by weight, for example by approximately 10%, 20%, 30%, 40%, 50%, 60%, 70%, 80% or 90% by weight.

The term “approximately” is intended to mean the value plus or minus 10% thereof, preferably plus or minus 5% thereof. For example, “approximately 100” means between 90 and 110, preferably between 95 and 105.

In a second preferential mode of the invention, the baked product is characterized in that at least two of the three ingredients chosen from eggs or egg products, milk or milk derivatives and fats of animal and/or vegetable origin have been partially or totally replaced with microalgal flour. In one particular embodiment, the milk or milk derivatives and either the eggs or egg products, or the fats of animal and/or vegetable origin, have been partially or totally replaced. In another particular embodiment, the eggs or egg products and either the milk or milk derivatives, or the fats of animal and/or vegetable origin, have been partially or totally replaced. In an additional particular embodiment, the fats of animal and/or vegetable origin and either the milk or milk derivatives, or the eggs or egg products, have been partially or totally replaced.

In a third preferential embodiment of the invention, the baked product is characterized in that all the ingredients chosen from eggs or egg products, milk or milk derivatives and fats of animal and/or vegetable origin have been partially or totally replaced with microalgal flour.

In one advantageous embodiment of the invention, the baked product is characterized in that the replacement of the eggs or egg products, and/or of the milk or milk derivatives and/or of the fats of animal and/or vegetable origin is total. In one very particular embodiment, the baked product is characterized in that the replacement of the eggs or egg products, of the milk or milk derivatives and of the fats of animal and/or vegetable origin is total.

Thus, in certain embodiments, the baked product now contains no allergenic ingredient chosen from eggs or egg products, milk or milk derivatives and/or fats of animal and/or vegetable origin, and can thus be consumed by individuals allergic to these ingredients, vegetarians, vegans and all those concerned about their figure, their fitness and their health.

In the present invention, the terms “baked product” and “breadmaking product” and also the term “bakery trade” should be interpreted broadly, as referring generally to the field of the production of products baked in an oven using starch-based fermented doughs, and also to the fields of the bakery trade and of Viennese pastry making.

In one preferential mode, the present invention relates to the baked products which traditionally contain eggs or egg products, and/or milk or milk derivatives and/or fats of animal and/or vegetable origin. They may more particularly be products such as brioches, sweet buns or panettones.

As a consequence of the replacement, the baked products according to the present invention have a calorie content which is lower than that of conventional baked products and/or are suitable for consumption by individuals who suffer from food allergies to one or more of the replaced ingredients or by vegetarian and vegan individuals and all those concerned by their figure, their fitness and their weight.

In the present invention, the flour used for the production of said baked products is in the form of a powder obtained by grinding and milling cereals. Each denotes in general wheat flours, i.e. conventional flours of the flour industry, from white flour to wholewheat flour.

In one preferred mode of the invention, the flour is a flour which does not contain gluten, and which can in particular be chosen from rice flour, chestnut flour, Lupin flour, chickpea flour, buckwheat flour, cornflour, quinoa flour, coconut flour, tiger nut flour, grapeseed flour, millet flour, hemp flour, and any mixtures thereof.

In another embodiment, the flour can be obtained from raw materials generally containing gluten but having been made “gluten-free” by special treatments well known to those skilled in the art. For example, the gluten can be extracted from flours naturally containing it by washing of starch. The dough obtained is rinsed and kneaded until the rinsing water becomes clear and is free of starch. Thus, the flour may also be of any botanical origin containing gluten, provided that it undergoes a particular process for removing the gluten. Thus, flours derived from wheat (or soft wheat or spelt), from barley, from rye or from triticale (wheat+rye) can also be used, provided that they are thoroughly devoid of gluten (gluten-free) after the extraction processes implemented.

Thus, in one particularly advantageous embodiment of the invention, the baked product does not contain gluten.

Gluten is a protein mixture combined with starch in the endosperm of most cereals. It constitutes approximately 80% of the proteins contained in wheat. Gluten is divided up into two groups: prolamins (gliadins in wheat), responsible for celiac disease and very pernicious intolerance, and glutenins.

In the present invention, the term “eggs or egg products” should be understood in its broadest interpretation and as denoting, for example, and in a nonlimiting manner, whole eggs including those which have a white or brown shell and which are of any animal origin, and equally egg substitutes, including egg derivatives, for instance and without limitation egg whites (albumen) and egg yolks, and which may be in various forms, such as concentrate, frozen, powdered, liquid, spray-dried, etc.

In breadmaking and the bakery trade, eggs are used to improve the taste and color of products. They also soften the dough, by virtue in particular of the lecithin that they contain. They also have a hydrating role in terms of the flour and create the moisture required for fermentation of the dough. Finally, they make it possible to increase the volume of the final products. It is because of eggs that brioches with an expanded volume are obtained.

In the present invention, the term “milk or milk derivatives” should be understood in its broadest interpretation and as denoting, for example, and in a nonlimiting manner, any product obtained following any treatment of the milk, which may contain food additives and other ingredients functionally necessary for the treatment (definition in the Codex Alimentarius). They may be, for example, fundamental milk ingredients, for instance skimmed or whole milk powders, caseins and caseinates, whey-product products, for instance sweet or acid wheys, serum proteins, or permeates.

In legal terms, only one clear definition, dating from 1909, exists defining milk of animal origin: “Milk is the integral product of the complete and uninterrupted milking of a healthy well-nourished milking female which is not overworked. It should be collected cleanly and not contain colostrum.” The word “milk” without any indication of the animal species of origin is, in terms of French legislation, reserved for cow's milk. Any milk originating from a milking female other than a cow should be denoted by the name “milk” preceded by the indication of the animal species from which it comes, for example “goat's milk”, “ewe's milk”, “ass milk”, “buffalo milk”, etc. However, for the purposes of the present invention, the milk and the milk products may originate from any animal species.

In breadmaking and the bakery trade, milk has a beneficial action on the dough and a positive effect on several phases of product production. It improves the structure and the hydration of doughs, promotes and regulates fermentation, and improves the baking of the dough and the flavor and also the coloring of the products upon baking. It also makes the crumb moist, and increases the shelflife of the final products. Milk is the second most common liquid element used by bakers.

Milk is also known to be a gustative agent. It slightly sweetens doughs and softens tastes and also makes it possible to fix flavors. It is a very good texturing agent. It makes doughs supple.

In the present invention, the term “fat of animal and/or vegetable origin” should be understood in its broadest interpretation and as denoting, for example, in a nonlimiting manner, any product chosen from butters, margarines or oils.

According to Article 1 of the Decree of Dec. 30, 1988, the name “butter” is reserved for the dairy product of water-in-fat emulsion type, obtained by physical processes and the constituents of which are of dairy origin. It must represent, for 100 g of final product, at least 82 g of butyric fat, at most 2 g of non-fat solids and at most 16 g of water. It results from the churning of milk cream, after maturation thereof. The butters according to the present invention may be dry or fatty butters. A dry butter is composed essentially of triglycerides containing fatty acids with a high melting point. A fatty butter is composed essentially of triglycerides containing fatty acids with a low melting point. The butters according to the present invention may also be fractionated. In order to compensate for the differences in plasticity of butter according to the season, manufacturers have improved butter by fractionating the fatty acid crystallization. The advantage for professionals is obvious. They have available throughout the year a raw material which is not only constant in terms of quality, but especially suited to their productions. The other modification carried out by manufacturers is concentration. All the water is removed from the butter (16% in a fresh butter). A concentrated butter, containing an average 99% fat, which stores very well, is obtained. This concentrated butter, which may or may not be fractionated, always has a tracer added to it, as soon as it is produced, in order to distinguish it from fresh butter, which itself is not concentrated. Finally, the butter may also be powdered.

According to the Decree of Dec. 30, 1988, the name “margarine” is reserved for the product obtained by mixing fat and water or milk or milk derivatives, which is in the form of an emulsion containing at least 82% of fat, of which at most 10% is of dairy origin. That said, most commonly, margarine is an oil-in-water emulsion supplemented with adjuvants of soya lecithin type.

According to the present invention, the fat of vegetable origin also denotes oils. Produced mainly from oleaginous plants, vegetable oils are the leading fatty substances consumed throughout the world. Two types of oils are distinguished: fluid oils extracted mainly from olive, peanut, sunflower, soya bean, rapeseed and wheat germ, which have the particularity of remaining liquid at 15° C.; and solid oils extracted from palm, from palm kernel and from copra (coconut) which are, on the other hand, set and solid at 15° C.

In one preferential mode of the present invention, the fat of animal and/or vegetable origin denotes butter.

In breadmaking and the bakery trade, fats of animal and/or vegetable origin have an important role. They facilitate the shaping and softening of doughs. They improve the gas-retaining capacity for better rising. They facilitate baking by virtue of their good thermal conductibility. They participate in the coloring of the crumb and of the crust. They make it possible to obtain a thinner crust and a more fondant crumb. They also have an influence on the taste and, finally, improve the storage of the final products.

According to the present invention, the microalgal flour used allows partial or total replacement of eggs or egg products, and of milk or milk derivatives and/or of fats of animal and/or vegetable origin in baked products.

According to one preferential mode of the present invention, the replacement is total.

The applicant has in fact found that, entirely surprisingly, the microalgal flour according to the present invention makes it possible to partially or totally replace ingredients as different as eggs, milk and butter in a baked product, while at the same time making it possible to obtain a product that has final organoleptic characteristics that are in all respects identical to the conventional baked product that would contain these three ingredients. No major modification of the functional, sensory and organoleptic properties of the baked products according to the present invention is to be noted.

With knowledge of the different role of each ingredient replaced, comes a complete awareness of the technical and technological prowess of the present invention. What is more, the baked products concerned can be prepared under the usual production conditions.

No modification of the production processes is required, which constitutes a major advantage for bakers and/or bakery product manufacturers.

Algae are among the first organisms which appeared on Earth, and are defined as eukaryotic organisms devoid of roots, stem and leaf, but having chlorophyll and also other secondary pigments in oxygen-producing photosynthesis. They are blue, red, yellow, golden and brown or else green. They represent more than 90% of marine plants and 18% of the plant kingdom, with their 40 000 to 45 000 species. Algae are organisms that are extremely varied both in terms of their size and their shape and in terms of their cell structure. They live in an aquatic or very humid medium. They contain numerous vitamins and trace elements, and are true concentrates of active agents that stimulate and are beneficial to health and beauty. They have anti-inflammatory, moisturizing, softening, regenerating, firming and anti-aging properties. They also have “technological” characteristics which make it possible to give a food product texture. Indeed, the famous additives E400 to E407 are in fact only compounds extracted from algae, the thickening, gelling, emulsifying and stabilizing properties of which are used.

Among the algae, macroalgae and microalgae can be distinguished, in particular single-celled microscopic algae, which are photosynthetic or non-photosynthetic, and of marine or non-marine origin, cultured in particular for their applications in biofuel or in the food sector. For example, spirulina (Arthrospira platensis) is cultured in open lagoons (under phototrophic conditions) for use as a food supplement or incorporated in small amounts into confectionery products or drinks (generally less than 0.5% w/w). Other lipid-rich microalgae, including certain species of Chlorella, are also very popular in Asian countries as food supplements (mention may be made of microalgae of the Crypthecodinium or Schizochytrium genus). The production and use of microalgal flours is described in applications WO 2010/120923 and WO 2010/045368.

For the purposes of the present invention, the term “microalgal flour” should be understood in its broadest interpretation and as denoting, for example, a composition comprising a plurality of particles of microalgal biomass. The microalgal biomass is derived from microalgal cells, which may be whole or broken, or a mixture of whole and broken cells.

The present invention thus relates to the microalgal biomass suitable for human consumption which is rich in nutrients, in particular in lipids and/or proteins.

The invention relates to a microalgal flour which can be incorporated into food products in which the lipid and/or protein content of the microalgal flour can totally or partially replace the oils and/or fats and/or proteins present in conventional food products.

The lipid fraction of the microalgal flour, which may be composed essentially of monounsaturated oils, thus provides nutritional and health advantages compared with the saturated, hydrogenated and polyunsaturated oils often found in conventional food products.

The protein fraction of the microalgal flour which contains many amino acids essential to human and animal well-being therefore also provides advantageous and not insignificant nutritional and health advantages.

For the purposes of the invention, the microalgae under consideration are species which produce appropriate oils and/or lipids and/or proteins.

According to the invention, the microalgal biomass comprises at least 10% by dry weight of lipids, preferably at least 12% and even more preferentially from 25% to 35% or more by dry weight of lipids.

Thus, according to the present invention, the expression “rich in lipids” should be interpreted as referring to contents of at least 10% by dry weight of lipids, preferably of at least 12% by dry weight of lipids and even more preferentially contents of at least 25% to 35% or more by dry weight of lipids.

According to one preferential mode of the invention, the microalgal biomass contains at least 12%, at least 25%, at least 50% or at least 75% by dry weight of lipids.

According to another embodiment of the invention, the microalgal biomass contains at least 30% by dry weight of proteins, at least 40% or at least 45% by dry weight of proteins.

Thus, depending on the ingredient to be replaced and depending on its class, in particular whether it is protein in nature or instead fat in nature, the baker will be able to choose to incorporate into his baked-product recipe instead a microalgal flour having a high content of lipids or instead a microalgal flour having a high protein content, a microalgal flour having both a high lipid and a high protein content, or else a mixture of the two types of microalgal flours.

According to another preferential mode of the invention, the microalgae belong to the Chlorella genus.

Chlorella (or Chlorella) is a freshwater microscopic green single-celled alga or microalga which appeared on Earth more than 3 billion years ago, belonging to the Chlorophyte branch. Chlorella possesses the greatest concentration of chlorophyll of all plants, and it has a considerable photosynthesis capacity. Since its discovery, chlorella has not ceased to generate considerable interest throughout the world, and today it is produced on a large scale for uses in food and nutritional supplements. Indeed, chlorella contains more than 60% of proteins which contain many amino acids essential to human and animal well-being. Chlorella also contains many vitamins (A, beta-carotene, B1: thiamine, B2: riboflavin, B3: niacin, B5: pantothenic acid, B6: pyridoxine, B9: folic acid, B12: cobalamin, vitamin C: ascorbic acid, vitamin E: tocopherol, vitamin K: phylloquinone), lutein (carotenoid family, powerful antioxidant) and minerals, including calcium, iron, phosphorus, manganese, potassium, copper and zinc. In addition, chlorella contains certain omega-type polyunsaturated fatty acids essential to good cardiac and brain function and to the prevention of numerous diseases such as cancer, diabetes or obesity.

There are a large number of benefits related to the consumption of chlorella. It is a food supplement used daily in Japan by 4 million people. It is used to such an extent that the Japanese government has classified it as a “food of national interest”.

Optionally, the microalgae used may be chosen, non-exhaustively, from Chlorella protothecoides, Chlorella kessleri, Chlorella minutissima, Chlorella sp., Chlorella sorokiniama, Chlorella luteoviridis, Chlorella vulgaris, Chlorella reisiglii, Chlorella ellipsoidea, Chlorella saccarophila, Parachlorella kessleri, Parachlorella beijerinkii, Prototheca stagnora and Prototheca moriformis. Preferably, the microalgae used according to the invention belong to the Chlorella protothecoides species. In the context of the invention, Chlorella protothecoides is chosen because of its high lipid composition. In a secondary embodiment, Chlorella protothecoides is also chosen because of its high protein composition.

In the microalgal flour, the cell walls of the microalgae and/or the cell debris of the latter may optionally encapsulate the lipids at least until the food product containing it is baked, thereby increasing the lifetime of the lipids.

The microalgal flour also provides other benefits, such as micronutrients, dietary fibers (soluble and insoluble carbohydrates), phospholipids, glycoproteins, phytosterols, tocopherols, tocotrienols and selenium.

According to one embodiment of the invention, the microalgae can be modified so as to reduce pigment production, or even totally inhibit it. For example, Chlorella protothecoides can be modified by UV-mutagenesis and/or chemical mutagenesis so as to have a reduced pigment content or to be devoid of pigments.

It may in fact be particularly advantageous to have microalgae free of pigment so as to avoid obtaining a more or less marked green color in the baked products in which the microalgal flour is used.

Since the microalgae are intended for the production of flours intended for food formulations, according to one preferred embodiment of the invention, the microalgae do not undergo any genetic modification, for instance mutagenesis, transgenesis, genetic engineering and/or chemical engineering. Thus, the microalgae have not undergone modifications of their genome by any molecular biology techniques whatsoever.

According to this preferred mode, the algae intended for the production of the microalgal flour have the GRAS status. The GRAS (Generally Recognized As Safe) concept, created in 1958 by the Food and Drug Administration (FDA), allows the regulation of substances or extracts added to foods and which are considered to be harmless by a panel of experts.

The appropriate culture conditions to be used are in particular described in the article by Ikuro Shihira-Ishikawa and Eiji Hase, “Nutritional Control of Cell Pigmentation in Chlorella protothecoides with special reference to the degeneration of chloroplast induced by glucose”, Plant and Cell Physiology, 5, 1964.

This article indicates in particular that all the color grades can be produced by Chlorella protothecoides (colorless, yellow, yellowish green, and green) by varying the nitrogen and carbon sources and ratios. In particular, “washed-out” and “colorless” cells are obtained using culture media which are glucose-rich and nitrogen-poor. The distinction between colorless cells and yellow cells is made in this article. Furthermore, the washed-out cells cultured in excess glucose and limited nitrogen have a high growth rate. Furthermore, these cells contain high amounts of lipids.

Other articles, such as the one by Han Xu, Xiaoling Miao, Qingyu Wu, “High quality biodiesel production from a microalga Chlorella protothecoides by heterotrophic growth in fermenters”, Journal of Biotechnology, 126, (2006), 499-507, indicate that heterotrophic culture conditions, i.e. in the absence of light, make it possible to obtain an increased biomass with a high content of lipids in the microalgal cells.

The solid and liquid growth media are generally available in the literature, and the recommendations for preparing the particular media which are suitable for a large variety of microorganism strains can be found, for example, online at www.utex.org/, a website maintained by the University of Texas at Austin for its algal culture collection (UTEX).

In the light of their general knowledge and the abovementioned prior art, those skilled in the art responsible for culturing the microalgal cells will be entirely capable of adjusting the culture conditions in order to obtain a large biomass, rich in proteins and/or in lipids and either totally free of or with a reduced content of chlorophyll pigments.

According to the present invention, the microalgae are cultured in liquid medium in order to produce the biomass as such.

According to the present invention, the microalgae are cultured in a medium containing a carbon source and a nitrogen source, either in the presence of light, or in the absence of light.

According to one preferred mode of the invention, the microalgae are cultured in a medium containing a carbon source and a nitrogen source in the absence of light (heterotrophic conditions).

The production of biomass is carried out in fermenters (or bioreactors). The specific examples of bioreactors, the culture conditions, and the heterotrophic growth and methods of propagation can be combined in any appropriate manner in order to improve the efficiency of the microbial growth and the lipids and/or of protein production.

In order to prepare the biomass for use in food compositions, the biomass obtained at the end of fermentation is concentrated or harvested from the fermentation medium. At the time of the harvesting of the microalgal biomass from the fermentation medium, the biomass comprises intact cells which are mostly in suspension in an aqueous culture medium.

In order to concentrate the biomass, a solid-liquid separation step is then carried out by filtration, by centrifugation or by any means known, moreover, to those skilled in the art.

After concentration, the microalgal biomass can be treated in order to produce vacuum-packed cakes, algal flakes, algal homogenates, algal powder, algal flour or algal oil.

The microalgal biomass is also dried in order to facilitate the subsequent treatment or for use of the biomass in its various applications, in particular food applications.

Various textures and flavors can be conferred on food products, depending on whether the algal biomass is dried, and if it is, depending on the drying method used. Reference may be made to patents U.S. Pat. No. 6,607,900 and U.S. Pat. No. 6,372,460 for example.

According to the present invention, the microalgal flour can be prepared from the concentrated microalgal biomass which has been mechanically lysed and homogenized, the homogenate then being spray-dried or flash-dried.

According to one embodiment of the invention, the cells used for the production of microalgal flour are lysed in order to release their oil or lipids. The cell walls and the intracellular components are ground or reduced, for example using a homogenizer, to non-agglomerated cell particles or debris. According to one preferential mode of the invention, the resulting particles have an average size of less than 500 μm, 100 μm or even 10 μm or less.

According to another embodiment of the invention, the lysed cells can also be dried.

For example, a pressure disruptor can be used to pump a suspension containing the cells through a restricted orifice so as to lyse the cells. A high pressure (up to 1500 bar) is applied, followed by an instantaneous expansion through a nozzle. The cells can be broken by three different mechanisms: running into the valve, high shear of the liquid in the orifice, and a sudden drop in pressure at the outlet, causing the cell to explode.

The method releases the intracellular molecules.

A Niro homogenizer (GEA Nori Soavi) (or any other high-pressure homogenizer) can be used to break cells.

This treatment of the algal biomass under high pressure (approximately 1500 bar) generally lyses more than 90% of the cells and reduces the size of the particles to less than 5 microns.

According to one embodiment of the invention, the pressure applied is from 900 bar to 1200 bar. Preferentially, the pressure applied is 1100 bar.

According to another embodiment, and in order to increase the percentage of lysed cells, the microalgal biomass may undergo a high-pressure double treatment, or even more (triple treatment, etc).

According to one preferred mode, a double homogenization is used in order to increase the percentage of lysed cells greater than 50%, greater than 75% or greater than 90%. The percentage of lysed cells of approximately 95% has been observed by means of this double treatment.

Lysis of the microalgal cells is optional but preferred when a flour rich in lipids (e.g. greater than 10%) is desired.

According to one embodiment of the invention, the microalgal flour is in the form of non-lysed cells.

According to another embodiment of the invention, partial lysis is desired, i.e. the microalgal flour is in the form of partially lysed cells and contains from 25% to 75% of lysed cells. According to another embodiment of the invention, maximum or even total lysis is desired, i.e. the microalgal flour is in the form of strongly or totally lysed cells and contains 85% or more of lysed cells, preferably 90% or more. Thus, in the present invention, the microalgal flour is capable of being in a non-milled form up to an extremely milled form with degrees of milling greater than 95%. Specific examples relate to microalgal flours having degrees of milling of 50%, 85% or 95% of cell lysis, preferably 85% or 95%.

In another embodiment of the invention, a protein-rich microalgal flour is produced. This protein-rich microalgal flour may be in the form of non-lysed cells (non-lysed and non-milled intact cells).

Alternatively, a ball mill is instead used. In this type of mill, the cells are agitated in suspension with small abrasive particles. The breaking of the cells is caused by the shear forces, the milling between the beads, and the collisions with beads. In fact, these beads break the cells so as to release the cell content therefrom. The description of an appropriate ball mill is, for example, given in the patent U.S. Pat. No. 5,330,913.

A suspension of particles, optionally of smaller size than the cells of origin, is obtained in the form of an “oil-in-water” emulsion. This emulsion can then be spray-dried and the water is eliminated, leaving a dry powder containing the cell debris and the lipids. After drying, the water content or the moisture content of the powder is generally less than 10%, preferentially less than 5% and more preferably less than 3% by weight.

However, the production of a dry powder which is tacky and flows with difficulty, since it contains oil in a content of 10%, 25% or even 50% by weight of the dry powder, is lamentable. Various flow agents (including silica-derived products) must then be added. Problems of water-dispersibility of the dried biomass flours, which is then have poorer wettability properties, may also be encountered.

The applicant company has developed microalgal flour granules which have a particular particle size distribution, and notable flow and wettability properties. In particular, these granules make it possible to stabilize the microalgal flour and to allow their easy, large-scale incorporation into food products which must remain delicious and nutritious.

The microalgal flour granules in accordance with the invention are thus characterized in that they have one or more of the following characteristics:
a monomodal particle size distribution, measured on a Coulter® LS laser particle size analyzer, of between 2 and 400 μm, centered on a particle diameter (D mode) between 5 and 15 μm,
flow grades, determined according to a test A, between 0.5% and 60% by weight for the oversize at 2000 μm, between 0.5% and 60% by weight for the oversize at 1400 μm and between 0.5% and 95% by weight for the oversize at 800 μm,
a degree of wettability, expressed according to a test B, by the height of the product decanted in a beaker, at a value of between 0 and 4 cm, preferably between 0 and 2 cm, and more preferentially between 0 and 0.5 cm.

Preferably, the microalgal flour granules have two of these characteristics, and even more preferably the three characteristics. According to one advantageous embodiment of the invention, the microalgal flour granules are characterized in that they have at least the three characteristics mentioned above.

The microalgal flour granules according to the invention can first be characterized by their particle size distribution, and particularly on the basis of their particle diameter. This measurement is carried out on a Coulter® LS laser particle size analyzer, equipped with its small volume dispersion module or SVM (125 ml), according to the constructor's specifications (in the “Small Volume Module Operating instructions”).

The microalgal flour particles are agglomerated during their preparation. Despite this agglomeration, the microalgal flour granules according to the invention also have entirely satisfactory flow properties, according to a test A.

These flow properties confer many advantages in the production of food products using the microalgal flour. For example, during the preparation of food products, many precise measurements of amount of flour must be carried out, and the flour aliquots are often prepared automatically. It is therefore essential for the flour and more particularly the microalgal flour to have a good flowability, so as not to cake in industrial automated systems.

The test A consists in measuring the degree of cohesion of the microalgal flour granules according to the invention.

The test A first of all consists in sieving the microalgal flour granules according to the invention on a sieve with a mesh opening of 800 μm. The flour granules which have a size of less than 800 μm are then recovered and placed in a closed container, and undergo mixing by epicycloidal motion using a Turbula laboratory mixer, type T2C. By virtue of this mixing, according to their own characteristics, the microalgal flour granules in accordance with the invention express their propensities to agglomerate or to repel one another.

The granules thus mixed are then deposited on a 3-sieve column (2000 μm; 1400 μm; 800 μm) for further sieving.

Once the sieving has ended, the oversize on each sieve is quantified and the result gives an illustration of the “cohesive” or “tacky” nature of the microalgal flour granules.

Thus, a free-flowing, and therefore not very cohesive, granule powder will virtually not be stopped by the large-opening sieves, but will be increasingly stopped the tighter the meshes of said sieves.

The protocol for measuring the particle size according to the test A is the following:
sieving the required amount of product on and 800 μm sieve in order to recover 50 g of product having a size less than 800 μm,
placing these 50 g of flour granules having a size of less than 800 μm in a glass jar with a volume of 1 liter (Ref. BVBL Verrerie Villeurbannaise-Villeurbanne France) and closing the lid,
placing this jar in the Turbula mixer, model T2C, adjusted to the speed of 42 rpm (Willy A. Bachofen Sarl-Sausheim-France) and mixing for 5 minutes,
preparing a 3-sieve column (of the brand Saulas—Diameter 200 mm; Paisy Cosdon—France) which will be placed on a Fritsch siever, model Pulverisette type 00.502; details of the assembly starting from the bottom to the top: siever, sieve bottom, 800 μm sieve, 1400 μm sieve, 2000 μm sieve, siever lid,
depositing the powder resulting from the mixing on the top of the column (2000 μm sieve), closing with the siever lid and sieving for 5 minutes on the Fritsch siever, with an amplitude 5 in the permanent position,
weighing the oversize on each sieve.

The microalgal flour granules according to the invention then exhibit:
between 0.5% and 60% by weight for the oversize at 2000 μm,
between 0.5% and 60% by weight for the oversize at 1400 μm, and
between 0.5% and 95% by weight for the oversize at 800 μm.

By way of comparison, the microalgal flour powders prepared by conventional drying techniques (single-effect spray-drying) have, for their part, a tacky aspect, of low fluidity, which results in a behavior according to the test A:
between 50% and 90% by weight of oversize on 2000 μm,
between 0.5% and 30% by weight of oversize on 1.400 μm,
between 5% and 40% by weight of oversize on 800 μm.

In other words, a majority of the microalgal flour powder (more than 50% of the powder) does not manage to cross the threshold of 2000 μm, although it was initially sieved on 800 μm.

These results demonstrate that the conventional drying techniques result instead in the production of very cohesive powders, since, after mixing, using little mechanical energy (sieving time of barely 5 min), particles less than 800 μm do not manage to pass through a 2000 μm sieve, with an opening which is nevertheless 2.5 times larger.

It is readily deduced therefrom that a conventional powder, exhibiting such a behavior, is not easy to use in a preparation where uniform distribution of the ingredients is recommended.

Conversely, the microalgal flours according to the present invention are easier to use since they are less tacky. This less tacky nature is obvious in the light of the numerous measurements including the small size of the granules, the high wettability and the improved flow.

The microalgal flour granules according to the invention exhibit only a low oversize (<50%) on 2000 μm for the family of granules of fine particle size and virtually no oversize (5%) for the family of granules of coarse particle size. It is therefore demonstrated that the microalgal flour particles produced according to the methods described in the present invention are less tacky than the microalgal flours prepared according to the conventional methods described in the prior art.

The microalgal flour granules according to the invention are, finally, characterized by a notable degree of wettability, according to a test B.

The wettability is a technological property very often used to characterize a powder resuspended in water, for example in dairy industries.

It reflects the ability of a powder to become immersed after having been deposited at the surface of water (Haugaard Sorensen et al., “Méthodes d'analyse des produits laitiers déshydratés” [“Methods for analyzing dehydrated milk products”], Niro A/S (publisher), Copenhagen, Denmark, 1978), and thus reflects the capacity of the powder to absorb water at its surface (Cayot P. and Lorient D., “Structures et technofonctions des protéines du lait” [“Structures and technofunctions of milk proteins”]. Paris: Airlait Recherches: Tec and Doc, Lavoisier, 1998).

The measurement of this index conventionally consists in measuring the time required for a certain amount of powder to penetrate into the water through its free surface at rest. According to Haugaard Sorensen et al. (1978), a powder is said to be “wettable” if its IM (Index of Wettability) is less than 20 seconds.

The swelling ability of the powder should also be associated with the wettability. This is because, when a powder absorbs water, it gradually swells. The structure of the powder then disappears when the various constituents are solubilized or dispersed.

Among the factors which influence wettability are the presence of large primary particles, the reintroduction of fines, the density of the powder, the porosity and the capillarity of the powder particles and also the presence of air, the presence of fats at the surface of the powder particles and the reconstitution conditions.

The test B developed by the applicant company consists here in considering more particularly the behavior of the microalgal flour powder when brought into contact with water, by measuring, after a certain contact time, the height of the powder which decants when placed at the surface of the water.

The protocol for this test is the following:
500 ml of demineralized water at 20° C. are placed in a low-form beaker of 600 ml (Fischerbrand FB 33114 beaker),
25 g of the microalgal flour powder are uniformly placed at the surface of the water, without mixing,
the behavior of the powder is observed after 3 h of contact,
the height of the product which has penetrated the surface of the water and which is decanted to the bottom of the beaker is measured.

A very cohesive, tacky powder of low wettability will remain at the surface of the liquid, while a powder of better wettability, which is less tacky, will decant more easily.

The microalgal flour granules according to the invention then have a degree of wettability, expressed according to this test B, by the height of the product decanted in a beaker, at a value of between 0 and 4 cm, preferably between 0 and 2 cm, and more preferentially between 0 and 0.5 cm.

By way of comparison, the flour of microalgae conventionally dried by single-effect spray-drying stays at the surface of the water, and does not hydrate sufficiently to be able to decant to the bottom of the beaker.

The microalgal flour granules according to the invention are also characterized by:
their bulk density,
their specific surface area and
their behavior after dispersibility in water.

The bulk density is determined according to a conventional method of measuring bulk density, i.e. by measuring the weight of an empty container (in grams) having a known volume, then by measuring the weight of the same container filled with the test product.

The difference between the weight of the filled container and the weight of the empty container, divided by the volume (in ml) of the container, gives the value of the bulk density.

For this test, the container having a volume of 100 ml that is used and the scraper and the measuring device that are sold by the company Hosokawa under the brand name Powder Tester type PTE, by applying the method recommended in the “operating instructions” for measuring a bulk density.

Under these conditions, the microalgal flour granules in accordance with the invention have a bulk density of between 0.30 and 0.50 g/ml.

This bulk density value is all the more notable since the microalgal flour granules in accordance with the invention have a higher density than the flour of conventionally dried microalgae. Indeed, it is accepted that the density of a product will be all the lower if it is granulated by spray-drying, for example less than 0.30 g/ml.

However, although granulated, the products in accordance with the invention have a higher than expected bulk density.

The microalgal flour granules in accordance with the invention may also be characterized by their specific surface area.

The specific surface area is determined on the whole of the particle size distribution of the microalgal flour granules using a Quantachrome specific surface area analyzer, based on a test for absorption of nitrogen on the surface of the product subjected to the analysis, carried out on an SA3100 instrument from Beckmann Coulter, according to the technique described in the article BET Surface Area by Nitrogen Absorption by S. Brunauer et al. (Journal of American Chemical Society, 60, 309, 1938).

The microalgal flour granules in accordance with the invention, after degassing for 30 minutes at 30° C. under vacuum, then have a specific surface area of between 0.10 and 0.70 m²/g.

By way of comparison, the flour of microalgae dried by conventional spray-drying has a specific surface area according to BET of 0.65 m²/g.

It is therefore surprising to note that the microalgal flour granules, which are more dense than the conventional microalgal flour, have a specific surface area which is all the smaller since their size is large.

To the knowledge of the applicant company, the particular properties of the microalgal flour granules have never been described. The microalgal flour granules of the invention are therefore easily differentiated from the microalgal flours obtained by simple spray-drying.

The microalgal flour granules in accordance with the invention are capable of being obtained by means of a particular spray-drying process, which uses high-pressure spray nozzles in a parallel-flow tower which directs the particles to a moving belt located in the bottom of the tower. The material is then transported as a porous layer through post-drying and cooling zones, which give it a crunchy structure, like that of a cake, which breaks up at the end of the belt. The material is then processed to obtain the desired particle size. In order to carry out the granulation of the algal flour, according to this spray-drying principle, a Filtermat™ spray-dryer sold by the company GEA Niro or a Tetra Magna Prolac Dryer™ drying system sold by the company Tetra Pak can be used for example.

Surprisingly and unexpectedly, the applicant company has thus noted that the granulation of the microalgal flour by implementing, for example, this Filtermat™ process makes it possible not only to prepare a product in accordance with the invention with a high yield in terms of particle size distribution and of its flowability, but also to give it unexpected wettability properties without the need to use granulation binders or anti-caking agents (although they may be optionally used). Indeed, the processes previously described (such as single-effect spray-drying) do not make it possible to obtain all of the desired characteristics.

According to one preferred embodiment of the invention, the process for preparing the microalgal flour granules in accordance with the invention comprises the following steps:

1) preparing an emulsion of microalgal flour with a solids content of between 15% and 40% by dry weight,

2) introducing this emulsion into a high-pressure homogenizer,

3) spraying in a vertical spray-dryer equipped with a moving belt at its base, and with a high-pressure nozzle in its upper part, while at the same time regulating:
a) the pressure applied at the level of the spray nozzles at values of more than 100 bar, preferably between 100 and 200 bar, and more preferably between 160 and 170 bar,
b) the input temperature between 150° C. and 250° C., preferably between 180° C. and 200° C., and
c) the output temperature in this spray-drying zone between 60° C. and 120° C., preferably between 60° C. and 110° C. and more preferably between 60° C. and 80° C.,

4) regulating the input temperatures of the drying zone on the moving belt between 40° C. and 90° C., preferably between 60° C. and 90° C., and the output temperature between 40° C. and 80° C., and regulating the inlet temperatures of the cooling zone at a temperature between 10° C. and 40° C., preferably between 10° C. and 25° C., and the output temperature between 20° C. and 80° C., preferably between 20° C. and 60° C.,

5) collecting the microalgal flour granules thus obtained.

The first step of the process of the invention consists in preparing a suspension of microalgal flour, preferably a lipid-rich microalgal flour (for example from 30% to 70%, preferably from 40% to 60%, of lipid by cell dry weight), in water with a solids content of between 15% and 40% by dry weight.

According to one preferential embodiment of the process for producing the microalgal flour according to the present invention, a biomass which can be at a concentration of between 130 g/l and 250 g/l, with a lipid content of approximately 50% by dry weight, a fiber content of from 10% to 50% by dry weight, a protein content of from 2% to 15% by dry weight, and a sugar content of less than 10% by weight, is obtained at the end of fermentation.

According to another embodiment of the process for producing the microalgal flour according to the present invention, a biomass which can be at a concentration of between 130 g/l and 250 g/l, with a protein content of approximately 50% by dry weight, a fiber content of from 10% to 50% by dry weight, a lipid content of from 10% to 20% by dry weight, and a sugar content of less than 10% by weight, is obtained at the end of fermentation.

According to the invention, the biomass extracted from the fermentation medium by any means known to those skilled in the art is then:
concentrated (for example by centrifugation),
optionally preserved by adding standard preservatives (sodium benzoate and potassium sorbate for example),
cellularly milled.

The emulsion can then be homogenized. This high-pressure homogenization of the emulsion can be accomplished in a two-stage device, for example a Gaulin homogenizer sold by the company APV, with a pressure of 100 to 250 bar at the first stage, and 10 to 60 bar at the second stage.

The suspension of flour thus homogenized is then sprayed in a vertical spray-dryer equipped with a moving belt at its base, and with a high-pressure nozzle in its upper part. The pressure applied at the level of the spray nozzles is regulated at values of more than 100 bar, preferably between 100 and 200 bar, more preferably between 160 and 170 bar, the input temperature is regulated so as to be between 150° C. and 250° C., preferably between 180° C. and 200° C., and the output temperature in this spray-drying zone is regulated so as to be between 60° C. and 120° C., preferably between 60° C. and 110° C. and more preferably between 60° C. and 80° C.

The moving belt makes it possible to move the material through the post-drying and cooling zones. The input temperature of the drying zone on the moving belt is regulated between 40° C. and 90° C., preferably between 60° C. and 90° C., and the output temperature of the drying zone is regulated between 40° C. and 80° C., and the input temperature of the cooling zone is regulated at a temperature between 10° C. and 40° C., preferably between 10° C. and 25° C., and the output temperature of the cooling zone is regulated between 20° C. and 80° C., preferably between 20° C. and 60° C.

The pressure applied and the input temperature of the drying zone are important parameters for determining the texture of the cake on the moving belt and therefore have an impact on the particle size distribution.

The microalgal flour granules according to the conditions of the preceding step of the process in accordance with the invention fall onto the moving belt with a residual moisture content of between 2% and 4%.

In order to bring the degree of moisture of the microalgal flour granules to the desired value of less than 4%, and move preferentially less than 2%, the applicant company has found that it is necessary to adhere to these drying- and cooling-zone temperature scales.

Optionally, an antioxidant (of butylhydroxyanisole (BHA) or butylhydroxytoluene (BHT) type, or others known for a food use) can be added before the drying step in order to maintain the freshness and the preservation.

The last step of the process in accordance with the invention consists, finally, in collecting the microalgal flour granules thus obtained.

Thus, the present invention also relates to the microalgal flour granules as defined in the present invention or as obtained by implementing the process described in the present invention.

According to one preferred mode of the invention, the microalgal flour granules contain at least 10% by dry weight of lipids, preferably at least 12% and even more preferentially from 25% to 35% or more by dry weight of lipids.

In one particular mode of the invention, the microalgal flour granules contain at least 25% of lipids, or at least 55% of lipids, expressed by dry weight.

The microalgal flour granules obtained according to the process described above are capable of containing intact microalgal cells, a mixture of intact microalgal cells and of milled cells or mainly milled microalgal cells.

In one embodiment of the present invention, non-extensive lysis is desired, i.e. the percentage of intact cells contained in the microalgal flour granules is between 25% and 75%.

According to another embodiment of the invention, partial lysis is desired, i.e. from 25% to 75% of lysed cells present in the microalgal flour.

According to another embodiment of the invention, total lysis is desired, i.e. the microalgal flour contains 85% or more of lysed cells, preferably 90% or more.

Thus, according to the desired applications, a microalgal flour which has a greater or lower content of lysed cells will be chosen.

As previously described and according to one preferred mode of the invention, the microalgal flour is in the form of microalgal flour granules. Said granules are produced according to the process as described above.

Thus, the microalgal flour of the present invention can be used as an ingredient in breadmaking products intended to be baked before they are consumed. It is in fact to the credit of the applicant to have discovered that a microalgal flour in the form of granules as defined in the present document, can, surprisingly and unexpectedly compared with the prerequisites of the prior art, advantageously replace eggs or egg products, milk or milk derivatized-products and fats of animal and/or vegetable origin in breadmaking products, while at the same time keeping the organoleptic qualities, in particular gustative, olfactory, visual and tactile properties, at least equivalent, or even superior, to those of conventional baked products containing these ingredients.

One embodiment of the invention therefore relates to a baked product characterized in that at least one of the three ingredients chosen from eggs or egg products, milk or milk derivatives and fats of animal and/or vegetable origin is partially or totally replaced with microalgal flour in the form of granules.

The present invention relates to the use of the microalgal flour in the form of granules, as defined in the present document, for preparing a baked product, preferably a breadmaking product. Optionally, the microalgal flour in the form of granules is used in the baked product, preferably breadmaking product, in a content of between 0.1% and 40%, more preferentially between 0.5% and 25% and even more preferentially between 1% and 10% of the total weight of the ingredients used in the recipe for preparing said baked product. Preferably, the microalgal flour totally or partially replaces at least one, two or three of the three ingredients chosen from eggs or egg products, milk or milk derivatives and fats of animal and/or vegetable origin.

The invention also relates to the process for producing a baked product, characterized in that it comprises adding, to the ingredients of the baked product, the microalgal flour in the form of granules as described in the present document. Preferably, it contains microalgal flour in the form of granules as partial or total replacement for at least one of the three ingredients chosen from eggs or egg products, milk or milk derivatives and fats of animal and/or vegetable origin, preferably for two of the ingredients and optionally for the three.

Said process is characterized in that it comprises the following steps:
mixing the various ingredients until a dough is obtained; and
baking said dough.

Finally, the present invention relates to a process intended to preserve or improve the organoleptic qualities of a baked product, in particular a breadmaking product, while at the same time reducing the content of at least one, two or three of the three ingredients chosen from eggs or egg products, milk or milk derivatives and fats of animal and/or vegetable origin, consisting in totally or partially replacing it (them) with the microalgal flour in the form of granules as described in the present document.

The invention will be understood more clearly on reading the examples which follow, which are intended to be illustrative while referring only to certain embodiments in certain advantageous properties according to the invention, and nonlimiting.

### EXAMPLES

### Example 1

### Production of the Microalgal Flour

A strain of Chlorella protothecoides, reference UTEX 250, is cultured in a fermenter and according to techniques known to those skilled in the art, in such a way that it does not produce chlorophyll pigment. The resulting biomass is then concentrated so as to obtain a final concentration of microalgal cells of 150 g/l.

The cells are optionally deactivated by heat treatment through an HTST zone at 85° C. for 1 minute.

For the rest of the operations, the temperature can be maintained under 8-10° C.

The washed biomass is then milled using a ball mill which may be of bead mill type, and several degrees of milling, in particular of lysis, are then sought: 50% milling and 85% milling.

In one of the embodiments, no milling is applied and the degree of milling is thus zero.

The biomass thus generated and optionally milled can then be pasteurized on an HTST zone (1 minute at 70-80° C.) and homogenized under pressure in a two-stage Gauvin homogenizer (250 bar at the 1st stage/50 bar at the second) after adjustment of the pH to 7 with potassium hydroxide.

Four batches of microalgal flour are thus obtained:
0% batch: no milling is applied;
50% batch: the degree of cell lysis after milling is 50%;
85% batch: the degree of cell lysis after milling is 85%;
95% batch: the degree of cell lysis after milling is 95%.

According to the culture conditions applied, the lipid content of the microalgal biomass is greater than 35%, and the protein content less than 20%.

### Example 2

### Drying of the Homogenized “Oil-in-Water” Emulsion of Microalgal Flour

The three batches of biomass obtained in example 1 are dried in a Filtermat device, so as to obtain the microalgal flour granules in accordance with the invention.

The spray-drying process in accordance with the invention consists in spraying the homogenized suspension at high pressure in a device of Filtermat type sold by the company GEA/Niro, fitted with a high-pressure injection nozzle of Delavan type, under the following conditions:
the pressure is regulated from 160 to 170 bar,
spray-drying input temperature: 180° C. to 200° C.,
output temperature: 60° C. to 80° C.,
drying zone input temperature: 60° C. to 90° C.,
output temperature: 65° C.,
cooling zone input temperature: 10° C. to 20° C.

The powder then reaches the belt with a residual moisture content of between 2% and 4%.

At the belt output: the microalgal flour granules have a residual moisture content of between 1% and 3%, about 2%.

### Example 3

### Impact of the Degree of Milling of the Microalgal Flour in a Brioche Application

The three batches of microalgal flour produced according to example 2 were tested in a brioche application so as to measure the impact of the milling on the final product.

The microalgal flours at various degrees of milling were compared with a flour where the lysis was almost total, greater than 95%.

The recipes are given in table 1 below. There was no modification in the recipe (same level of incorporation and same hydration of the dough). Only the kneading time was adjusted to the various products, in order to form “comparable” doughs.

TABLE 1
Brioche composition:

| | Microalgal | | Microalgal | | Microalgal | | Microalgal | |
|---|---|---|---|---|---|---|---|---|
| | flour | | flour | | flour | | flour | |
| | 0% milling | | 50% milling | | 85% milling | | 95% milling | |
| | g | % | g | % | g | % | g | % |
| Wheat flour | 970.0 | 47.6% | 970.0 | 47.6% | 970.0 | 47.6% | 970.0 | 47.6% |
| Wheat gluten | 30.0 | 1.5% | 30.0 | 1.5% | 30.0 | 1.5% | 30.0 | 1.5% |
| Microalgal flour | 150.0 | 7.4% | 150.0 | 7.4% | 150.0 | 7.4% | 150.0 | 7.4% |
| Sucrose | 100.0 | 4.9% | 100.0 | 4.9% | 100.0 | 4.9% | 100.0 | 4.9% |
| Prefera SSL 600 | 5.0 | 0.2% | 5.0 | 0.2% | 5.0 | 0.2% | 5.0 | 0.2% |
| Lametop 300 | 3.0 | 0.1% | 3.0 | 0.1% | 3.0 | 0.1% | 3.0 | 0.1% |
| Ascorbic acid | 0.1 | 0.0% | 0.1 | 0.0% | 0.1 | 0.0% | 0.1 | 0.0% |
| Nutrisoft 55 | 0.1 | 0.0% | 0.1 | 0.0% | 0.1 | 0.0% | 0.1 | 0.0% |
| Salt | 20.0 | 1.0% | 20.0 | 1.0% | 20.0 | 1.0% | 20.0 | 1.0% |
| Glucidex 2 maltodextrin | 34.0 | 1.7% | 34.0 | 1.7% | 34.0 | 1.7% | 34.0 | 1.7% |
| Dry yeast | 15.0 | 0.7% | 15.0 | 0.7% | 15.0 | 0.7% | 15.0 | 0.7% |
| Powdered skimmed milk | 20.0 | 1.0% | 20.0 | 1.0% | 20.0 | 1.0% | 20.0 | 1.0% |
| Flolys E7081S glucose syrup | 70.0 | 3.4% | 70.0 | 3.4% | 70.0 | 3.4% | 70.0 | 3.4% |
| Water at 4° C. | 620.0 | 30.4% | 620.0 | 30.4% | 620.0 | 30.4% | 620.0 | 30.4% |
| | 2037.2 | 100% | 2037.2 | 100% | 2037.2 | 100% | 2037.2 | 100% |

Improvers Used:

Prefera SSL6000: emulsifier of Sodium Stearoyl Lactate type

Nutrisoft 55: emulsifier of monoglyceride type

Lametop 300: DATEM (diacetyl tartaric acid ester) of mono- and diglycerides

These three improvers are sold by the company BASF Chemtrade GmbH, Burgbernheim, Germany.

The Glucidex 2 maltodextrins and the Flolys E7081S glucose syrup are produced and sold by the applicant company.

Brioche Preparation Protocol
Introduction of the various ingredients into the kneading machine.
Kneading for 2 minutes at speed 1, then from 12 minutes to 19 minutes at speed 2. The amount of kneading at speed 2 is adjusted so as to obtain comparable doughs at the output of the kneading machine. Thus, for the non-milled microalgal flour, it is 12 minutes; for the microalgal flour milled at 50%, it is 13 minutes; for the microalgal flour milled at 85%, it is 15 minutes; and for the microalgal flour milled at 95%, it is 17 minutes.
Bulk fermentation for 20 minutes.
Cutting up, weighing (dough piece of 500 g) and shaping.
Slackening of the dough pieces for 20 minutes.
Forming of the dough pieces.
Proving or proofing in an oven at 28° C., 80% RH for 2 h 30 min.
Baking in a hearth oven at 180° C. for 30 minutes.

TABLE 2
Analysis of the final products

| | Microalgal | Microalgal | Microalgal | Microalgal |
|---|---|---|---|---|
| | flour | flour | flour | flour |
| | 0% milling | 50% milling | 85% milling | 95% milling |
| Height (cm) | 10.5 | 11.2 | 13.3 | 13.5 |
| Weight (g) | 447.9 | 441.0 | 431.4 | 430.3 |
| Water lost during baking (%) | 10.4% | 11.8% | 13.7% | 13.9% |
| Density (g) (3 slices 50 mm in diameter) | 12.5 | 11.5 | 8.8 | 8.0 |
| Calculated volume (cm³) | 2101 | 2156 | 2888 | 2965 |
| Softness D + 1 (N) | 3.5 | 2.4 | 1.2 | 1.1 |
| Softness D + 3 (N) | 4.3 | 2.8 | 1.3 | 1.1 |
| Softness D + 7 (N) | 6.2 | 4.2 | 2.4 | 1.3 |
| aw D + 1 | 0.94 | 0.95 | 0.95 | 0.95 |
| aw D + 3 | 0.94 | 0.95 | 0.94 | 0.94 |
| aw D + 7 | 0.94 | 0.94 | 0.95 | 0.94 |
| % H₂O J + 1 | 37.5 | 37.5 | 37.2 | 37.6 |
| % H₂O J + 3 | 36.8 | 36.1 | 34.3 | 35.3 |
| % H₂O J + 7 | 35.3 | 36.8 | 36.1 | 34.3 |

These tests demonstrate that it is entirely possible to carry out brioche recipes using microalgal flour according to the present invention with different degrees of milling.

Certain parameters are dependent on the degree of milling. Indeed, while the degree of milling increases:
the volume also increases, indicating better proofing of the brioche. Nevertheless, entirely satisfactory volumes are obtained both when the microalgal cells are not milled or when they are milled only at 50%.
The water losses on baking increase, which means that the non-milled microalgal cells have greater water-retention capacities than the milled microalgal cells.
The density decreases with the degree of milling, which is logical since it correlates with the suppleness and softness of the brioche. The higher the degree of milling, the more expanded and therefore soft is the brioche. The soft nature is inversely proportional to the hardness measured in Newtons and indicated in the table above under the name softness.

Other results do not appear to correlate with the degree of milling. Thus, the change in the water content of the final products does not follow any logic. The water activities of the brioches over time change very little.

Sensory Analysis of the Final Products:

Eight individuals participated in the sensory evaluation of the brioches produced with microalgal flour at various degrees of milling.

The four brioches were judged to be good, even though the two tests where the microalgal flour was milled at 85% and 95% were judged to be the best, in terms of softness. It should be noted that there is no significant difference between the 2 brioches produced with these two high degrees of milling.

In conclusion, it appears that the degree of milling has an impact on the texture of the brioche. The higher the degree of milling, the softer and more aerated is the brioche.

That said, such tests demonstrate that it is entirely possible to prepare brioches in which the microalgal flour has not been milled.

Depending on the marketing positioning of the final product, it may be advantageous from an economical point of view to dispense with the milling step, which is an expensive step in the process for preparing the microalgal flour.

In order to correct the density of the brioche with non-milled microalgal flour, it is perhaps necessary to correct the dehydration of the dough in order to soften the latter and to give the baked final product the soft nature. This is what was done in the following example 4.

### Example 4

### Impact of the Degree of Milling of the Microalgal Flour in a Brioche Application—Comparison Between 0% and 85% Degree of Milling

In example 3, the brioches containing microalgal flour gave a rather firm dough which appeared to lack hydration and therefore resulted in baked final products with less softness.

The applicant therefore carried out further tests in which the hydration of the dough was corrected. Several degrees of hydration of the dough with non-milled algal flour were carried out and the best results are those obtained for a degree of hydration of 78%.

TABLE 3
Brioche composition

| | Microalgal flour | | Microalgal flour | |
|---|---|---|---|---|
| | 85% milling | | 0% milling | |
| | g | % | g | % |
| Wheat flour | 970.0 | 47.6% | 970.0 | 44.1% |
| Wheat gluten | 30.0 | 1.5% | 30.0 | 1.4% |
| Microalgal flour | 150.0 | 7.4% | 150.0 | 6.8% |
| Sucrose | 100.0 | 4.9% | 100.0 | 4.6% |
| Prefera SSL 600 | 5.0 | 0.2% | 5.0 | 0.2% |
| Lametop 300 | 3.0 | 0.1% | 3.0 | 0.1% |
| Ascorbic acid | 0.1 | 0.0% | 0.1 | 0.0% |
| Nutrisoft 55 | 0.1 | 0.0% | 0.1 | 0.0% |
| Salt | 20.0 | 1.0% | 20.0 | 0.9% |
| Glucidex 2 maltodextrin | 34.0 | 1.7% | 34.0 | 1.5% |
| Dry yeast | 15.0 | 0.7% | 15.0 | 0.7% |
| Powdered skimmed milk | 20.0 | 1.0% | 20.0 | 0.9% |
| Flolys E70815S glucose syrup | 70.0 | 3.4% | 70.0 | 3.2% |
| Water at 4° C. | 620.0 | 30.4% | 780.0 | 35.5% |
| | 2037.2 | 100% | 2197.2 | 100% |

The preparation protocol is identical to that described in example 3. The kneading is carried out for 2 minutes at speed 1, then at speed 2 from 15 minutes for the microalgal flour cells milled at 85%, and for 12 minutes for the non-milled microalgal flour.

The results on the baked products are entirely satisfactory, and the fact that the degree of hydration was increased makes it possible to obtain a dough which has an acceptable texture similar to the texture of the brioche prepared with the microalgal flour milled at 85%.

This very high increase in hydration makes it possible to obtain a dough with a texture close (in terms of the strength of the dough and of its suppleness) to the dough prepared with a microalgal flour milled at 85%.

This example demonstrates that, if the degree of hydration of the dough is adjusted, brioches with an entirely satisfactory softness and suppleness are obtained.

Another example, not presented herein, demonstrated that, if the degree of hydration and the amount of gluten were adjusted, the quality of the brioches was further improved, more particularly on the brioches containing non-mil microalgal flour. Thus, in the brioches containing slightly milled flour (50%) or non-milled flour (0%), if 0.5% and 1% of gluten, respectively, was added, the suppleness of the dough and the final softeners were further increased.

### Example 5

### Replacement of the Allergenic and/or High-Calorie Ingredients in Brioches with Microalgal Flour

A first series of tests consisted in eliminating powdered skimmed milk from brioches in favor of microalgal flour in order to remove this allergenic ingredient from the formula.

The flour used is the one produced in example 2 with a degree of milling of 85%.

A control brioche is prepared containing powdered milk and not containing microalgal flour.

A brioche formula containing powdered milk and microalgal flour is then prepared. This is test 1. A third formula (Test 2) consists of a brioche without milk and with microalgal flour, in which the part of powdered milk removed is replaced with wheat flour. There was no other modification in the recipe between test 1 and test 2, other than this substitution of skimmed milk and replacement with wheat flour.

TABLE 4
Brioche composition:

| | CONTROL | | TEST 1 | | TEST 2 | |
|---|---|---|---|---|---|---|
| | Control brioche | | Brioche with | | Brioche with | |
| | with milk without | | microalgal flour | | microalgal flour | |
| | microalgal flour | | and milk | | without milk | |
| Wheat flour | 1120 | 55.9 | 970.0 | 48.3% | 990.0 | 49.3% |
| Wheat gluten | 30 | 1.5% | 30.0 | 1.5% | 30.0 | 1.5% |
| Microalgal flour | 0 | 0 | 150.0 | 7.5% | 150.0 | 7.5% |
| Sucrose | 100 | 5.0% | 100.0 | 5.0% | 100.0 | 5.0% |
| Flolys E7081S glucose syrup | 70 | 3.5% | 70.0 | 3.5% | 70.0 | 3.5% |
| Salt | 20 | 1.0% | 20.0 | 1.0% | 20.0 | 1.0% |
| Glucidex 2 maltodextrin | 30 | 1.5% | 30.0 | 1.5% | 30.0 | 1.5% |
| Dry yeast | 15 | 0.7% | 15.0 | 0.7% | 15.0 | 0.7% |
| Lametop 300 | 3 | 0.1% | 3.0 | 0.1% | 3.0 | 0.1% |
| Prefera SSL 600 | 5 | 0.2% | 5.0 | 0.2% | 5.0 | 0.2% |
| Powdered skimmed milk | 20 | 1.0% | 20.0 | 1.0% | 0.0 | 0.0% |
| Water at 4° C. | 595 | 29.6% | 595.0 | 29.6% | 595.0 | 29.6% |
| | 2008 | 100% | 2008 | 100% | 2008 | 100% |

Brioche Preparation Protocol
Introduction of the various ingredients into the kneading machine.
Kneading for 2 minutes at speed 1, then for 15 minutes at speed 2.
Bulk fermentation for 20 minutes.
Cutting up, weighing (dough pieces of 500 g) and shaping.
Slackening of the dough pieces for 20 minutes.
Forming of the dough pieces.
Proving or proofing in an oven at 28° C., 80% RH for 2 h.
Baking in a hearth oven at 215° C. for 23 minutes.

In terms of the kneading, for test 1, the dough is formed conventionally. It is supple and easy to handle. For test 2, no difference is noted. The dough is also really supple and really handlable.

TABLE 5
Analysis of the final products

| | | Brioche with | Brioche with |
|---|---|---|---|
| | Control brioche with milk | microalgal flour and | microalgal flour |
| | without microalgal flour | milk | without milk |
| Aw (D + 1) | 0.938 | 0.934 | 0.931 |
| % H₂O | 36.8% | 38% | 34.7% |
| Height (cm) | 10.11 | 9.23 | 10.27 |
| Weight (g) | 446.8 | 448.9 | 444.6 |
| Water lost during baking (%) | 10.6% | 10.2% | 11% |
| Calculated volume (cm³) | 1854.25 | 1766.6 | 1973.3 |

| | |
|---|---|
| Texture | NO DIFFERENCE IN TEXTURE |

The two formulae containing microalgal flour are very similar to the control formula which contains milk, but no microalgal flour.

If test 1 and test 2 are compared, it can be said that no significant difference is observed. Nevertheless, the average volume measured on the brioches without milk is greater (by approximately 10%). The loss of water during baking, the volume and the percentage of water in the final product appear to correlate with the slight increase in volume of the brioche without milk and might be explained by a greater evaporation during baking. The differences observed are minimal and not representative.

The three brioches obtained according to the recipes above using the microalgal flour as a replacement for milk according to the present invention were also tasted by a panel of tasters, and the taste of said brioches was judged to be very satisfactory and pleasant. The texture was noted as being supple and soft.

It is therefore entirely possible to envision definitively eliminating this allergen from the brioche formula without thereby having an impact on the production or the final organoleptic qualities.

### Example 6

### Partial Replacement of Fats for a Reduction in the Calorie Content in a Cake Formula

The three batches of microalgal flour at 0%, 50% and 85% milling, produced according to example 2, were tested in a cake application for a reduction in fat content and a reduction in calorie content. The fats used are of vegetable type and are rapeseed (or canola) oil.

A fourth test was also carried out with a microalgal flour having a degree of milling of 95%.

The recipes are given in table 6 below. They were the same regardless of the degree of milling of the microalgal flour used.

TABLE 6
Cake composition

| | | Control | | Microalgal flour | |
|---|---|---|---|---|---|
| | | g | % | g | % |
| A | Wheat flour | 250.0 | 25.0% | 250.0 | 25.0% |
| | Microalgal flour | 0.0 | 0.0% | 15.0 | 1.5% |
| | Sucrose | 160.0 | 16.0% | 160.0 | 16.0% |
| | Powdered skimmed milk | 36.0 | 3.6% | 36.0 | 3.6% |
| | Powdered whole milk | 25.0 | 2.5% | 25.0 | 2.5% |
| | Spongolit 283 emulsifier | 8.0 | 0.8% | 8.0 | 0.8% |
| | Volcano chemical yeast | 6.0 | 0.6% | 6.0 | 0.6% |
| | Salt | 3.0 | 0.3% | 3.0 | 0.3% |
| B | Flolys E70815 glucose syrup | 160.0 | 16.0% | 160.0 | 16.0% |
| | Liquid whole eggs | 160.0 | 16.0% | 160.0 | 16.0% |
| | Water | 52.0 | 5.2% | 77.0 | 7.7% |
| | Vanilla extract | 10.0 | 1.0% | 10.0 | 1.0% |
| | Glycerol | 50.0 | 5.0% | 50.0 | 5.0% |
| | Canola (rapeseed) oil | 80.0 | 8.0% | 40.0 | 4.0% |
| | | 1000.0 | 100% | 1000.0 | 100% |

The Volcano chemical yeast is sold by the company Puratos, industrialaan 25, 1702 Groot-Bijgaarden, Belgium.

The Spongolit 283 cake emulsifier is sold by the company BASF Chemtrade GmbH, Burgbernheim, Germany.

Brioche Preparation Protocol
Mix together the various powders of group A.
Place the ingredients of group B in the bowl of the mixer and add them to the mixture of the powders from group A.
Mix everything for 30 seconds at speed 1, then for 3 minutes at speed 2 and finally for 30 seconds at speed 3.
Place the mix in a greased aluminum mold (235 g).
Bake in an oven at 170° C. for 27 minutes.

TABLE 7
Analysis of the final products

| | Control | Microalgal flour |
|---|---|---|
| Calories (kCal/kJ) | 397 kCal/1659 kJ | 371 kCal/1553 kJ |
| Proteins | 7.4 | 7.6 |
| Fats | 11.9 | 8.3 |
| Carbohydrates | 56.3 | 57.7 |
| . . .among which DP1,2 | 31.9 | 32.7 |
| Fibers | 0.5 | 0.8 |
| . . . insoluble fibers | 0.5 | 0.8 |
| . . . soluble fiber | 0.0 | 0.0 |
| Glycerol | 5.5 | 5.6 |

| | |
|---|---|
| Fat reduction | 30.6% |
| Calorie reduction | 6.5% |

Thus, the cake recipe containing microalgal flour, regardless of the degree of milling, enables a 30% reduction in fat in the final product.

Furthermore, the two types of cakes were tasted blind by a panel of tasters, and the taste of said cakes was judged to be very satisfactory and pleasant. No difference in terms of texture, moistness or taste was demonstrated.

The same style of replacement was tested in muffin recipes and gave the same results. Muffins that were just as delicious were prepared with fat replacements of 30%.

### Example 7

### Total Replacement of Eggs or Egg Products, of Milk or Milk Derivatives and of Fats of Animal and/or Vegetable Origin in a Brioche Recipe

In this final example, all the ingredients of the type eggs or egg products, milk or milk derivatives and fats of animal and/or vegetable origin were totally replaced with microalgal flour according to the invention in brioche recipes.

For this test, the microalgal flour is milled at 85%.

TABLE 8
Brioche composition

| | Control | | Microalgal flour | |
|---|---|---|---|---|
| | g | % | g | % |
| Wheat flour | 970.0 | 47.9% | 970.0 | 47.9% |
| Wheat gluten | 30.0 | 1.5% | 30.0 | 1.5% |
| Microalgal flour | 0 | 0.0% | 490 | 24.2% |
| Sucrose | 100.0 | 4.9% | 100.0 | 4.9% |
| Flolys E7081S glucose syrup | 70.0 | 3.5% | 70.0 | 3.5% |
| Salt | 20.0 | 1.0% | 20.0 | 1.0% |
| Glucidex 2 maltodextrin | 30.0 | 1.5% | 30.0 | 1.5% |
| Dry yeast | 15.0 | 0.7% | 15.0 | 0.7% |
| Powdered skimmed milk | 20.0 | 1.0% | 0 | 0.0% |
| Nutrilife AM17 | 0.2 | 0.0% | 0.2 | 0.0% |
| Ascorbic acid | 0.2 | 0.0% | 0.2 | 0.0% |
| Lametop 300 | 3.0 | 0.1% | 3.0 | 0.1% |
| Prefera SSL 6000 | 5.0 | 0.2% | 5.0 | 0.2% |
| Vanilla extract | 15.0 | 0.7% | 15.0 | 0.7% |
| Butter containing 82% fats | 270.0 | 13.3% | 0 | 0.0% |
| Water at 4° C. | 230.0 | 11.4% | 275.0 | 13.7% |
| Whole eggs | 245.0 | 12.1% | 0 | 0.0% |
| | 2023.4 g | 100% | 2023.4 g | 100% |

Brioche Preparation Protocol
Introduction of the various ingredients into the kneading machine.
Kneading for 2 minutes at speed 1, then from 12 minutes to 19 minutes at speed 2. The amount of kneading at speed 2 is adjusted so as to obtain comparable doughs at the output of the kneading machine. Thus, it is 12 minutes for the control, and 15 minutes for the test.
Bulk fermentation for 20 minutes.
Cutting up, weighing (dough piece of 500 g) and shaping.
Slackening of the dough pieces for 20 minutes.
Forming of the dough pieces.
Proving or proofing in an oven at 28° C., 80% RH for 2 h 30 min.
Baking in a hearth oven at 180° C. for 30 minutes.

The two batches of doughs behave in the same way.

Analysis of the Final Products

The two brioches obtained according to the recipes above, the control recipe and the one using the microalgal flour as a replacement for eggs or egg products, milk or milk derivatives and fats of animal and/or vegetable origin according to the present invention were tasted by a panel of tasters, and the taste of said brioches was judged to be very satisfactory and pleasant. The texture was noted as being supple and soft.

It is therefore entirely possible to envision definitively eliminating eggs or egg products, milk or milk derivatives and fats of animal and/or vegetable origin from the brioche formula without thereby having an impact on either the production or the final organoleptic properties.

The advantage of the present invention is thus demonstrated by the numerous examples above.

1-19. (canceled)

20. A baked product that it is obtained by adding, to the ingredients of the baked product, microalgal flour in the form of granules having one or more of the following characteristics:
a monomodal particle size distribution, measured on a particle size analyzer, of between 2 and 400 μm, centered on a particle diameter (D mode) between 5 and 15 μm,
flow grades, determined according to a test A, between 0.5% and 60% by weight for the oversize at 2000 μm, between 0.5% and 60% by weight for the oversize at 1400 μm and between 0.5% and 95% by weight for the oversize at 800 μm,
a degree of wettability, expressed according to a test B, by the height of the product decanted in a beaker, at a value of between 0 and 4 cm.

21. The baked product as claimed in claim 20, wherein the microalgal flour content is between 0.1% and 40% of the total weight of the ingredients used in the recipe for preparing said product.

22. The baked product as claimed in claim 20, wherein at least one of the three ingredients chosen from eggs or egg products, milk or milk derivatives and fats of animal and/or vegetable origin has been partially or totally replaced with microalgal flour.

23. The baked product as claimed in claim 20, wherein at least two of the three ingredients chosen from eggs or egg products, milk or milk derivatives and fats of animal and/or vegetable origin have been partially or totally replaced with microalgal flour.

24. The baked product as claimed in claim 20, wherein all the ingredients chosen from eggs or egg products, milk or milk derivatives and fats of animal and/or vegetable origin have been partially or totally replaced with microalgal flour.

25. The baked product as claimed in claim 24, wherein the replacement of the eggs or egg products, of the milk or milk derivatives and/or of the fats of animal and/or vegetable origin is total.

26. The baked product as claimed in claim 20, wherein the baked product does not contain gluten.

27. The baked product as claimed in claim 20, wherein the microalgal flour is a flour in which the microalgae are of the Chlorella genus.

28. The baked product as claimed in claim 20, wherein the microalgal biomass contains at least 12% by dry weight of lipids.

29. The baked product as claimed in claim 20, wherein the microalgal biomass contains at least 30% by dry weight of proteins by dry weight of proteins.

30. The baked product as claimed in claim 20, wherein the microalgal flour is in the form of non-lysed cells.

31. The baked product as claimed in claim 20, wherein the microalgal flour is in the form of partially lysed cells and contains from 25% to 75% of lysed cells.

32. The baked product as claimed in claim 31, wherein the microalgal flour is in the form of strongly lysed cells and contains 85% or more of lysed cells.

33. The baked product as claimed in claim 20, wherein the baked product is a breadmaking product.

34. A process for preparing a baked product as claimed in claim 20 comprising:
mixing the various ingredients until a dough is obtained, and
baking said dough.

35. The process of claim 34, wherein at least one, two or three of the three ingredients chosen from eggs or egg products, milk or milk derivatives and fats of animal and/or vegetable origin is totally or partially replaced with the microalgal flour in the form of granules.

36. A process intended for preserving or improving the organoleptic qualities of a baked product, in particular a breadmaking product, while at the same time reducing the content of at least one, two or three of the three ingredients chosen from eggs or egg products, milk or milk derivatives and fats of animal and/or vegetable origin, comprising in totally or partially replacing it (them) with a microalgal flour granules having one or more of the following characteristics:
a monomodal particle size distribution, measured on a particle size analyzer, of between 2 and 400 μm, centered on a particle diameter (D mode) between 5 and 15 μm,
flow grades, determined according to a test A, between 0.5% and 60% by weight for the oversize at 2000 μm, between 0.5% and 60% by weight for the oversize at 1400 pin and between 0.5% and 95% by weight for the oversize at 800 μm,
a degree of wettability, expressed according to a test B, by the height of the product decanted in a beaker, at a value of between 0 and 4 cm.

37. The baked product as claimed in claim 20, wherein the microalgal flour content is between 0.5% and 25% of the total weight of the ingredients used in the recipe for preparing said product.

38. The baked product as claimed in claim 20, wherein the microalgal flour content is between 1% and 10% of the total weight of the ingredients used in the recipe for preparing said product.

39. The baked product as claimed in claim 20, wherein the microalgal flour is a flour in which the microalgae are of the Chlorella protothecoides species.

40. The baked product as claimed in claim 20, wherein the microalgal biomass contains at least 25% by dry weight of lipids.

41. The baked product as claimed in claim 20, wherein the microalgal biomass contains at least 50% by dry weight of lipids.

42. The baked product as claimed in claim 20, wherein the microalgal biomass contains at least 75% by dry weight of lipids.
